(19) United States
(12) Patent Application Publication
(10) Pub. No.: US 2009/0125526 A1
(43) Pub. Date: May 14, 2009

(54) SYSTEM AND METHOD FOR PROVIDING AUTOMATED NON-VOLATILE OFFLINE ACCESS TO RELATIONAL DATA

(76) Inventor: Brent Neufeld, Barrie (CA)

Correspondence Address: MILLER THOMPSON, LLP, Scotia Plaza, 40 King Street West, Suite 5800, TORONTO, ON, M5H 3S1, CA

(21) Appl. No.: 12/270,261

(22) Filed: Nov. 13, 2008

Related U.S. Application Data
(60) Provisional application No. 60/987,746, filed on Nov. 13, 2007.

(51) Int. Cl. G06F 17/30; G06F 12/00; H04L 9/32

(52) U.S. Cl. 707/10; 707/201; 707/9; 707/E17.127

(57) ABSTRACT

A system and method for providing automated non-volatile offline access to on-line relational data. The system provides offline access to local relational data and automatically synchronizes the local relational data with a central on-line relational data store. Specifically the system comprises one or more local databases stored on one or more client computers; the central on-line database containing a plurality of data; a network connection between the one or more local subset databases and the central on-line database and a computer program interface application resident in the memory of the one or more client computers having computer readable coded embodied therein for execution by a central processing unit (CPU) operable to access the central on-line database and in the event of a loss of network connectivity, allowing one or more client computers to continue to locally access previously accessed data from the central on-line database and upon the re-establishing of the network connection, synchronizing the one or more local subset databases to the central on-line database.

### FIELD OF INVENTION

The present invention relates to a system for providing automated non-volatile offline access to on-line relational data. Specifically the invention provides offline access to local relational data and automatically synchronizes the local relational data with a central on-line relational data store.

### BACKGROUND

Databases or database management systems are well known and have been incorporated into myriad applications. In the distributed network context, databases have been used in gaming technology to provide central gaming servers and the information stored therein. In the software and hardware development arenas, databases have proven invaluable in the collection, tracking and subsequent resolution of product issues. As a last example, databases have addressed the ever growing need of companies to capture and retain customers. Customers now have an increased access to information along with an increased selection of wares and services. This translates into a decreased corresponding cost to the customer of switching loyalties. As one would expect, this situation has created a very competitive environment and led to the development and improvement of customer relationship management (CRM) applications.

With the advent of the Internet and distributed communication networks in general, so too database users are distributed globally. Often times, these database users may not be able to connect to the central database or database management system.

Traditional offline capable systems require routing rules to be set up to control what offline data goes to what individual during a database initialization process. Further, each local computer that makes use of such a traditional system is required to perform a database initialization process. This database initialization process can be very time consuming, labor intensive from the perspective of the local computer and restrictive to the end-user wherein only a pre-set computer may be used for off-line access.

What is required is a system that allows for access a database (or a subset of the database) locally and once network connectivity has been re-established, synchronization may be performed. In addition a system that does not require routing rules or a database initialization is also required.

### SUMMARY OF INVENTION

In accordance with one aspect of the present invention, a system for synchronizing data between one or more local subset databases and a central on-line database comprising one or more local databases stored on one or more client computers; the central on-line database containing a plurality of data; a network connection between the one or more local subset databases and the central on-line database and a computer program interface stored in a memory of the one or more client computers having computer readable code embodied therein for execution by a central processing unit (CPU) operable to access the central on-line database and in the event of a network connection loss, allowing one or more client computers to continue to locally access a previously accessed data from the central on-line database and upon re-establishing network connectivity, synchronizing the one or more local subset databases to the central on-line database is provided.

In another aspect of the present invention, a system wherein the computer program interface receives all data from the central on-line database in the form of a dataset is provided.

In a still other aspect of the present invention, a system wherein the computer program interface stores all previously accessed data locally from the central on-line database in the form of a local dataset is provided.

In yet another aspect of the present invention, a system whereupon loss of network connectivity or upon termination of the computer program interface, the local dataset is encrypted and stored on a client computer's hard drive is provided.

### DETAILED DESCRIPTION

The present invention describes a system wherein a client to a web accessible on-line central database may access data, store that data locally on the client's computer, if required modify that data and transmit the modified data to the web accessible on-line central database. Further, the present invention provides for a system that allows for the client to access and modify previously accessed data locally on the client's computer with or without contiguous network connectivity. Upon a reestablishment of the network connection to the web accessible on-line central database, the modified data is automatically synchronized with the on-line central database. Therefore, the system is operable in two distinct modes: on-line and off-line.

Registering with the System:

A new client commences their transaction with the web accessible on-line central database by creating a client login and password. Once created, the new client may successfully login to the system. The new client then downloads a computer program interface application to their local client computer. In one embodiment of the present invention, the new client may access the computer program interface application which is depicted as a resident application on the new client's computer operating system desktop.

Once the computer program interface application has been installed, the new client may input their login information. The computer program interface receives configuration information from the central on-line database. This configuration information defines the business logic of the computer program interface and essentially sets out the user options, and the display of the computer program interface.

The new client is then permitted to perform standard database queries. The new client requested information is sent to the on-line central database and the on-line central database response is in the form of a subset of the database or a dataset. In one embodiment of the present invention the dataset may take the form of an Extensible Markup Language (XML) file.

Periodically during an active on-line session the local computer program interface will poll the on-line central database to verify if any changes to the data stored therein have been applied. This check may be performed on a pre-set temporal basis. In one current embodiment of the present invention, this temporal basis is set at two (2) minutes. If there has been a change to the central database, an update reflecting the change will be sent to the local computer program interface in the form of a dataset.

Likewise, if the new client performs a modification (changes, deletes or adds) on the locally stored dataset, this change will be automatically propagated to the on-line central database wherein a synchronization of the data will be performed.

At the end of the session, the user terminates the computer program interface application thereby causing all accessed datasets to be encrypted and stored locally on the client computer's hard drive as offline dataset information. Further, the login information of the new client is encrypted and stored locally as a configuration file.

In another embodiment of the present invention, the computer program interface application performs periodic interim saves during the client's database session.

Off-Line Mode

For whatever reasons, the client may no longer be connected to the web accessible on-line central database. This may occur for several reasons including if the user is no longer operating within the range of a mobile network, the network itself may be down, or the client is purposely operating in an off-line mode but is desirous of launching the computer program interface application.

The client activates the computer program interface application. The client is once again prompted to enter their login information to commence their session. The computer program interface polls the central on-line database, but due to the lack of connectivity the request is timed out thereby informing the local computer program interface application that it will be operating in off-line mode. This off-line mode result directs the computer program interface application to a Configuration file locally stored on the client computer's hard drive. The configuration file is loaded into the client computer's memory, decrypted and compared to the client's recent login attempt. If the attempt is successful (i.e. the login information matches), the computer interface program is directed to the encrypted offline dataset information. The encrypted dataset information is loaded into the memory of the client's computer, decrypted and loaded into an in-memory local representation of the web accessible central database. Apart from being off-line, the session permits the client to perform the same tasks as a client functioning in online mode for example, adding new database records, modifying current database records, deleting database records. However it should be noted that each deleted record is not actually deleted, but rather tagged and marked as deleted. The deleted data is logged into a deletes table or dataset which can be readily propagated to other clients.

Once the client's tasks are completed, the client closes the computer program interface application, thereby causing the generation of a configuration file (as previously described), in addition, to causing all datasets to be encrypted and stored locally (as previously described) as a local dataset.

On-Line Mode

Once connectivity with the Internet has been re-established, the client may launch the computer program interface application (in the manner as described above). However, the computer program interface application determines that it is in on-line mode. As such, the client's login information is confirmed remotely, and a special configuration file is downloaded to the computer program interface application. In addition, the client is free to query the central database. The resulting requested data from the central database is received by the client's computer memory via a secure web service request. In one embodiment of the present invention, this resulting requested data is in the form of an XML file representing the relational dataset. The dataset is then merged into the main dataset of the client computer program interface application which drives the data seen on the client computer program interface application. Further, the client computer program interface application performs a check to see if there is an encrypted dataset file stored locally on the client computer from a previous session. In this case, the computer program interface application locates such a file. The file is loaded into memory, decrypted and subsequently loaded into a temporary dataset. This temporary dataset is then subsequently merged into the main dataset. In addition, the temporary dataset is also sent to the central database wherein an additional merge is performed. The dataset is transmitted to the central database via a secure web service and in an encrypted form.

Before the dataset is transmitted to the on-line central database, the on-line central database is polled, whereupon a time stamp is sent back to the client computer program interface application. In one embodiment of the present invention, the time stamp takes the form of the current GMT time. The time stamp is affixed to the temporary dataset before it is transmitted to the central database. The time stamp assists the system such that only changed datasets are sent to other clients.

It should be further noted that since the present invention does not require any routing rules or a database initialization any computer may be used to access the central online database.

1. A system for synchronizing data between one or more local subset databases and a central on-line database comprising:
a. one or more local databases stored on one or more client computers;
b. the central on-line database containing a plurality of data;
c. a network connection between the one or more local subset databases and the central on-line database; and
d. a computer program interface stored in a memory of the one or more client computers having computer readable code embodied therein for execution by a central processing unit (CPU) operable to access the central on-line database and in the event of a network connection loss, allowing the one or more client computers to continue to locally access a previously accessed data from the central on-line database and upon re-establishing network connectivity, synchronizing the one or more local subset databases to the central on-line database.

2. The system of claim 1 wherein the computer program interface receives all data from the central on-line database in the form of a dataset.

3. The system of claim 2 wherein the computer program interface stores all previously accessed data locally from the central on-line database in the form of a local dataset.

4. The system of claim 3 wherein upon a loss of network connectivity or a termination of the computer program interface, the local dataset is encrypted and stored on a client computer hard drive.

5. The system of claim 4 wherein the computer program interface is operable to modify the previously accessed data from the central on-line database with or without network connectivity and upon reestablishing network connectivity is operable to receive a dataset which is synchronized to the stored dataset and a resulting merged dataset is sent to the central on-line database.

6. The system of claim 5 wherein the computer program interface polls the central on-line database at a pre-determined time for any changes to the central on-line database.

7. The system of claim 6 wherein the changes to the central on-line database are transmitted to the computer program interface in the form of a dataset.

8. The system of claim 7 wherein the dataset is in the form of an Extensible Markup Language (XML) file.

9. The system of claim 8 wherein the dataset is received by the computer program interface via a secure web service request.

10. The system of claim 9 wherein the dataset is transmitted by the computer program interface via a secure web service request.

11. The system of claim 10 wherein the central on-line database is password protected.

12. A computer readable medium useful in association with a computer which includes a central processing unit (CPU) and a memory whereby an on-line database, and the computer readable medium includes computer instructions operable to access the on-line database and locally store a subset of the on-line database, and to allow the computer to continue to access the subset of the on-line database in the event of network connection loss with the on-line database and to synchronize the local subset of the database with the on-line database upon re-establishing the network connection.

13. A method of synchronizing data between one or more local databases and a central on-line database comprising:
a. providing a central on-line database;
b. providing one or more client computers with a memory operable to store a local subset of the central on-line database;
c. connecting the one or more client computers with the central on-line database to locally store the subset of the central on-line database; and
d. allowing the one or more client computers to continue to access the local subset of the central on-line database in the event of a network connection loss, and to synchronize the one or more local subsets of the central on-line database to the central on-line database upon re-establishing the network connection.
